(19) United States
(12) Patent Application Publication
(10) Pub. No.: US 2023/0208127 A1
(43) Pub. Date: Jun. 29, 2023

(54) SHIELDED IN-LINE CONNECTOR

(71) Applicant: COMMSCOPE TECHNOLOGIES LLC, Hickory, NC (US)

(72) Inventors: Timothy ANDERSON, Omaha, NE (US); Shawn Phillip TOBEY, Trinity, NC (US)

(73) Assignee: COMMSCOPE TECHNOLOGIES LLC, Hickory, NC (US)

(21) Appl. No.: 17/922,529

(22) PCT Filed: Apr. 8, 2021
(86) PCT No.: PCT/US2021/026394

§ 371 Date: Oct. 31, 2022

Related U.S. Application Data
(60) Provisional application No. 63/017,971, filed on Apr. 30, 2020.

(51) Int. Cl. H02G 15/068; H01R 4/48

(52) U.S. Cl. CPC H02G 15/068; H01R 4/4809

(57) ABSTRACT

A shielded in-line connector includes conductive first and second body portions, each with a securement feature, as well as conductive first and second clips. The first and second body portions are secured to one another to define an unshielded connector-receiving cavity as well as first and second shielded cable openings; each of the first and second shielded cable openings being proximate the respective clip securement feature. Each of the clip securement features includes a channel supportive of a respective shielded cable extending from each of the first and second shielded cable openings; each of the shielded cables having an exposed shield. The first and second clips are adjustably secured to a respective one of the first and second securement features to position the respective clip in direct contact with the exposed shield of the respective shielded cable.

### CROSS-REFERENCE TO RELATED APPLICATION

This application is being filed on Apr. 8, 2021 as a PCT International Patent Application and claims the benefit of U.S. Patent Application Ser. No. 63/017,971, filed on Apr. 30, 2020, the disclosure of which is incorporated herein by reference in its entirety.

### TECHNICAL FIELD

The present disclosure is directed to electrical connectors and, more specifically, to shielded in-line connector.

### BACKGROUND

In-line devices for connecting or splicing two cables carrying pairs of twisted wire leads are generally known. In applications wherein electromagnetic interference (EMI), or “noise,” is of little or no concern, unshielded twisted pair (UTP) cables are used. In-line connectors for use with UTP cables are designed without shielding considerations. In applications where noise is of concern, shielded twisted pair (STP) cables are used. Typically, the use of an STP cable would require a new connector design that includes shielding features. However, design of a completely new connector utilizes valuable engineering resources. Ideally, it would be possible to use a previously designed UTP connector in an STP application.

### SUMMARY

The present disclosure is directed to a shielded in-line connector that can be used in combination with an unshielded twisted pair (UTP) in-line connector to supply the shielding capabilities absent from the UTP in-line connector. The shielded in-line connector provides the electrical coupling with one or more shielding elements of each of first and second shielded twisted pair (STP) cables whose one or more twisted pairs are electrically coupled by the UTP connector. The shielded in-line connector provides electrical continuity from the first STP cable to the second STP cable with the shield ultimately connected to ground and serving to reduce electromagnetic noise (EMI).

An aspect of the present disclosure is directed to a shielded in-line connector. The shielded in-line connector includes conductive first and second body portions, each with a clip securement feature, as well as conductive first and second clips. The first and second body portions are secured to one another to define an unshielded connector-receiving cavity as well as first and second shielded cable openings; each of the first and second shielded cable openings being proximate the respective clip securement feature.

Each of the clip securement features includes a channel supportive of a respective shielded cable extending from each of the first and second shielded cable openings; each of the shielded cables having an exposed shield. The first and second clips are adjustably secured to a respective one of the first and second securement features to position the respective clip in direct contact with the exposed shield of the respective shielded cable.

Another aspect of the present disclosure is directed to a shielded in-line connector system. The shielded in-line connector system includes the shielded in-line connector described immediately above and an unshielded in-line connector that is enclosed by the shielded connector. The unshielded in-line connector electrically couples the one or more pairs of conductors the first shielded twisted pair cable to the one or more pairs of conductors of the second shielded twist pair cable

Still another aspect of the present disclosure is directed to a method of coupling first and second shielded twisted pair cables. For each of the first and second shielded twisted pair cables the method includes: stripping a portion of a jacket of the respective cable; folding back a shield, of the respective cable, over a remaining portion of the jacket of the cable to reveal one or more twisted pairs of conductors; and connecting the one or more pairs of conductors to contacts within an unshielded in-line connector serving to electrically couple the first and second shielded twist pair cables. The method further includes enclosing the unshielded in-line connector with a shielded in-line connector. The shielded in-line connector includes a conductive housing having first and second cable openings to accommodate the first and second shielded cables extending from the unshielded in-line connector. The shielded in-line connector further includes a first clip securement feature proximate the first cable opening and a second clip securement feature proximate the second cable opening; each of the first and second securement features including a cable-supporting channel that supports the respective first and second shielded twisted pair cable. The method further includes securing a first and second conductive clip to a respective one of the first and second clip securement features to position the respective first and second conductive clips in direct contact with the shields of the respective first and second shielded cables.

### BRIEF DESCRIPTION OF THE DRAWINGS

FIGS. 1A and 1B provide perspectives of a prior art unshielded twisted pair (UTP) in-line connector in an exploded view and an assembly view, respectively.

FIG. 2 is a perspective of the UTP in-line connector of FIGS. 1A and 1B in combination with a shielded in-line connector of the present disclosure.

FIG. 3 is a perspective view of the assembled UTP in-line connector of FIGS. 1A and 1B contained within a first body portion of the shielded in-line connector and a second body portion of the shielded in-line connector removed.

FIG. 4 is a perspective exploded view of the shielded in-line connector.

FIGS. 5A-5B are interior and exterior plan views of the shielded in-line connector.

FIG. 6A is a cross-sectional view of the of the shielded in-line connector taken along an elongate axis extending from a first cable opening to a second cable opening of the shielded in-line connector.

FIG. 6B is a perspective view of one of the body portions of the shielded in-line connector illustrating various lip edge features.

FIGS. 7A-7B are a side elevation of the shielded in-line connector and a detail view taken from FIG. 7A with a first body portion of the shielded in-line connector separated from a second body portion of the shielded in-line connector, respectively.

FIG. 8 is a perspective view of a spring clip of the shielded in-line connector.

FIGS. 9A-9B are end perspective views of the shielded in-line connector illustrating a spring clip of the shielded in-line connector in an unsecured position and a secured position, respectively.

FIG. 10A-10C are perspective assembly views of a single shielded in-line connector and a plurality of shielded in-line connectors coupled with cable ties, and a plurality of stacked shielded in-line connectors, respectively.

FIGS. 11A-11G Illustrate a first method of coupling the shielded in-line connector between two shielded cables.

FIGS. 12A-12C Illustrate a second method of coupling the shielded in-line connector between two shielded cables.

FIG. 13 illustrates a pigtail application of the shielded in-line connector.

### DETAILED DESCRIPTION

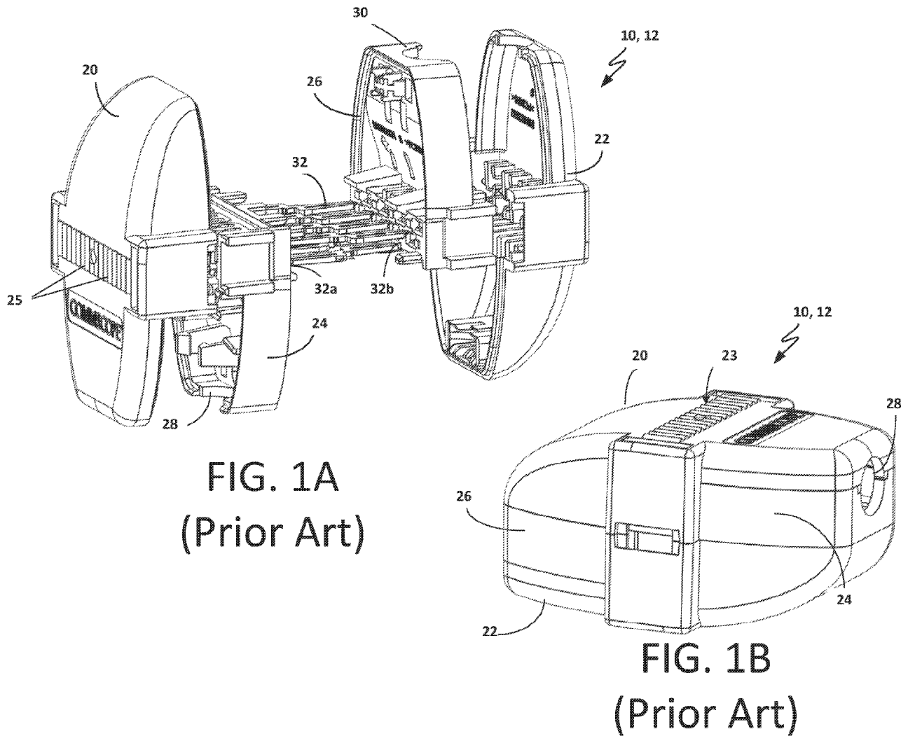

FIGS. 1A and 1B illustrate an example of a prior art unshielded in-line connector 10 suitable for use with an unshielded twist pair (UTP) cable. The in-line connector 10 is used to connect one or more pairs of wire leads of a first cable to a second cable. The in-line connector 10 generally comprises a housing structure 12 that includes a first base 20 and a second base 22, which is identical to the first base 20 but oppositely oriented; each of the first and second bases 20, 22 include a ratchet strip 23 having a plurality of teeth 25. The in-line connector 10 additionally includes a first wiring cap 24 and a second wiring cap 26, which is identical to the first wiring cap 24 but oppositely oriented. Upon assembly, the first wiring cap 24 engages the first base 20 and defines a first cable opening 28. Further, the second wiring cap 26 engages the second base 22 and defines a second cable opening 30. The in-line connector 10 additionally includes one or more pairs of doubled ended insulation displacement contacts 32 (IDCs). A first end 32a of the IDC 32 is configured to be electrically coupled to a lead of a twisted pair of a first cable and a second end 32b of the IDC 32 is configured to be electrically coupled to a lead of a twisted pair of a second cable.

Further details regarding the unshielded in-line connector 10 can be found in PCT Publication WO 2018/075769, entitled “In-line Cable Connector Assembly and Methods” and having an international filing date of Oct. 19, 2017. The identified PCT Publication is hereby incorporated by reference in its entirety. It should be noted that the in-line connector of FIGS. 1A and 1B is but one example of many possible unshielded in-line connectors with which the shielded connector of the present disclosure may be used.

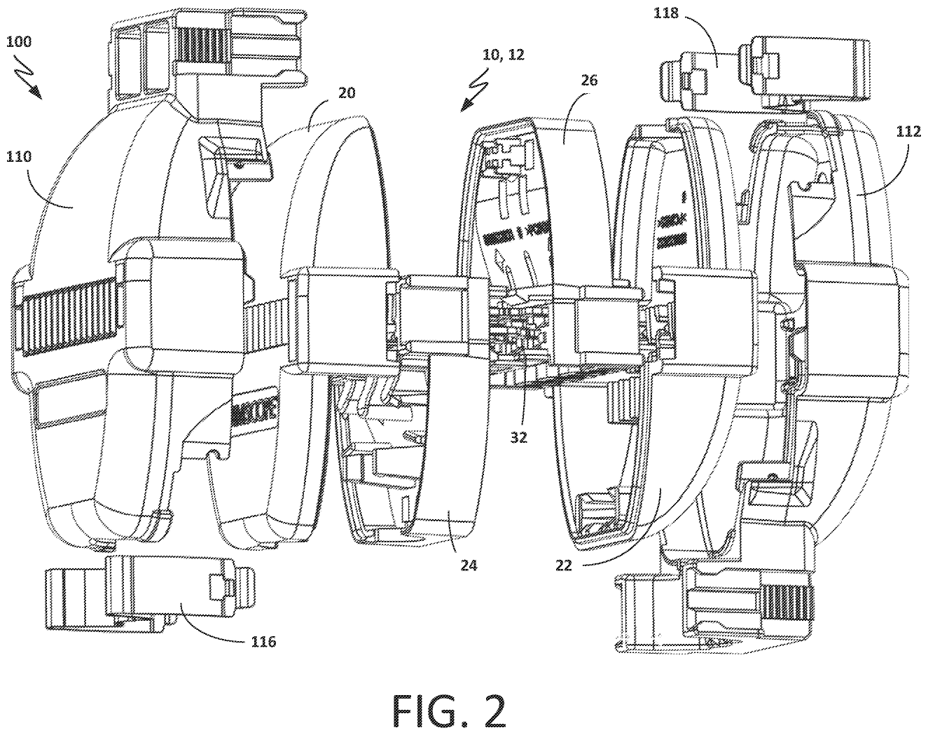

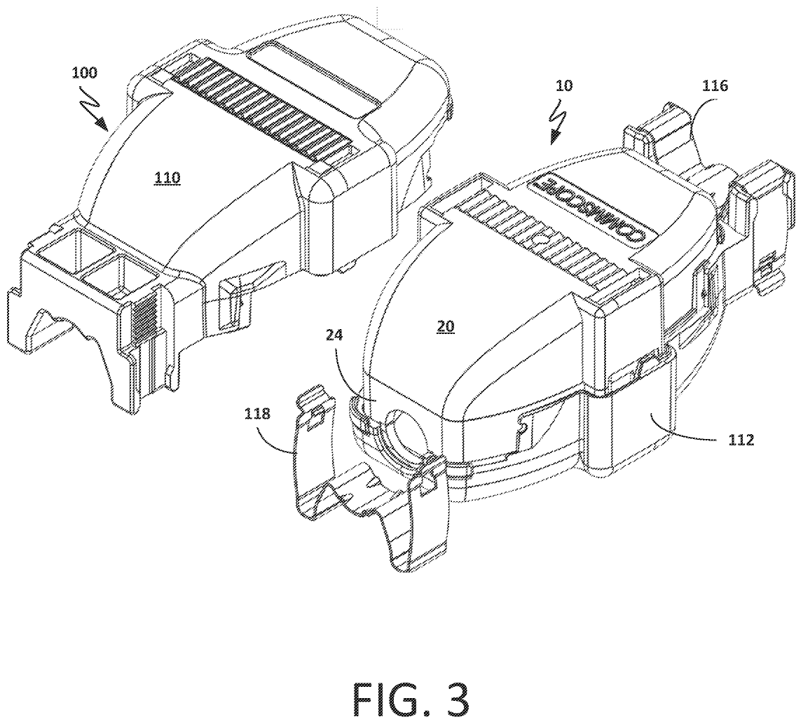

FIGS. 2 and 3 provide an exploded view and a semi-assembled view, respectively, of the unshielded in-line connector 10 in position to be enclosed by a shielded in-line connector 100 of the present disclosure. In certain embodiments, as illustrated, the shielded in-line connector 100 mimics the shape of the unshielded connector 10 that it will enclose. In other embodiments, the shielded in-line connector 100 has a distinctive shape from that of the unshielded in-line connector it will enclose.

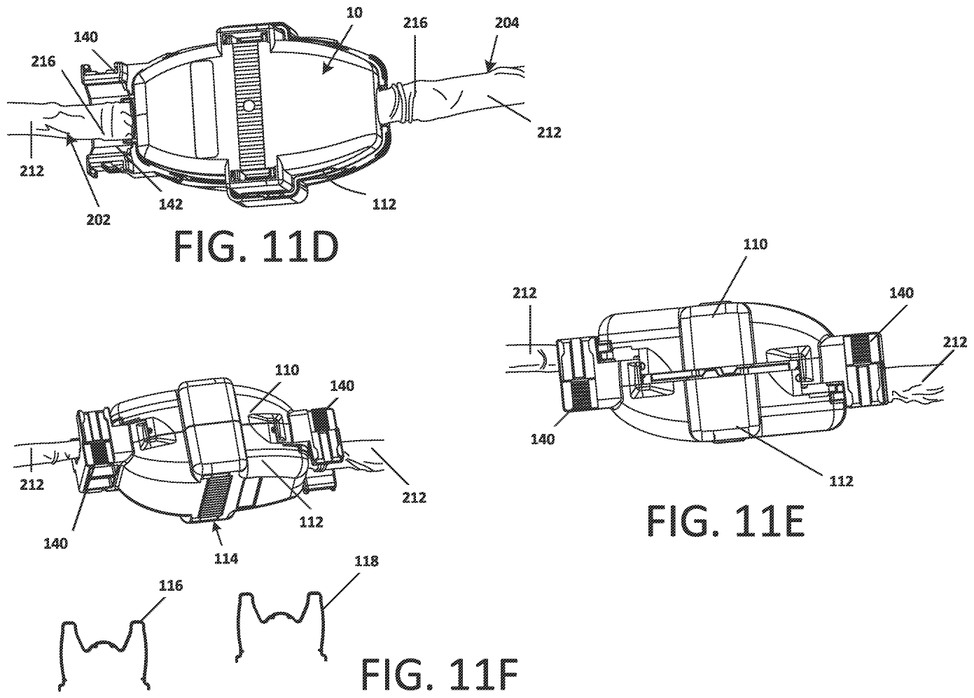

The shielded in-line connector 100 generally comprises a first body portion 110 and a second body portion 112, which is identical but oppositely oriented to the first body portion 110. Together the first and second body portions 110, 112 form a housing 114 (see FIG. 10A) of the shielded in-line connector 100. The shielded in-line connector 100 further includes a first spring clip 116 and a second spring clip 118. In certain embodiments, the first and second body portions 110, 112 are die cast components fabricated with a metal or metal alloy and finished with one or more conductive metals. Other fabrication processes and/or materials (or combination of materials) are also possible. In certain embodiments, the first and second spring clips 116, 118 are die cut from stainless steel and finished with one or more conductive metals; other fabrication processes and/or materials (or combination of materials) are also possible.

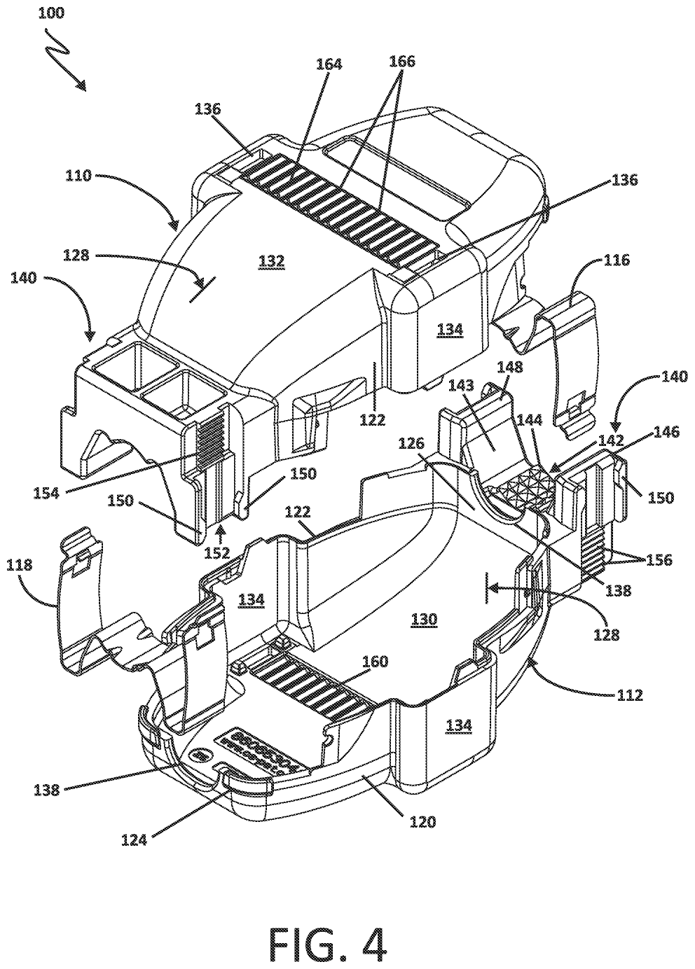

Further details of the shielded in-line connector 100 of the present disclosure can be appreciated with respect to FIGS. 4-10C. It should be noted that first and second body portions 110, 112 are identical as are first and second spring clips 116, 118 so that a description of one body portion applies to the other body portion and a description of one spring clip applies to the other spring clip.

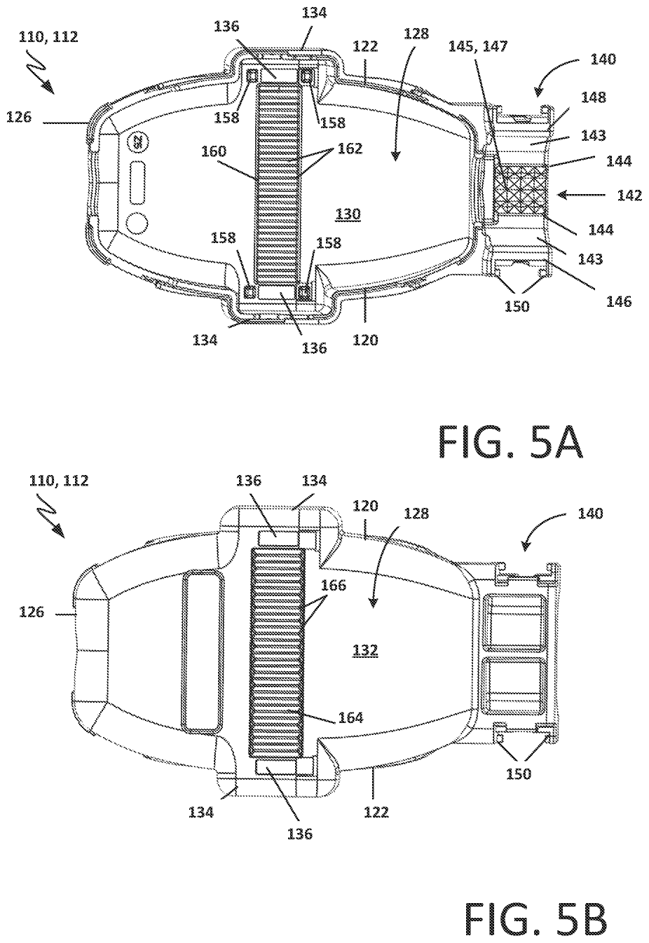

Referring to FIGS. 4 and 5A-5B, each of the first and second body portions 110, 112 includes a first side wall 120 and second side wall 122. which are connected by a first end wall 124 and a second end wall 126. The walls 120-126 define a perimeter of a face 128, having an inner surface 130 and an outer surface 132, and further define an opening to an interior cavity of the body portion 110, 112.

Each of the first and second side walls 120, 122 includes a shoulder projection 134 establishing a space between the unshielded connector 10, which is placed within the body portion 110, 112 (see FIG. 3), and the respective side wall 120, 122. Each shoulder projection 134 includes a slot 136 through which a cable tie can be passed; see cable tie 192 securing two shielded in-line connectors in FIG. 1013.

Each of the first and second end walls 124, 126 includes a recess 138. When the first and second body portions 110, 112 are secured to one another, the combined recesses 138 define an opening to accommodate a diameter of a twisted pair cable. The second end wall 126 further includes a clip securement feature 140. The clip securement feature 140 defines a channel 142 to the recess 138. The channel 142 incorporates a cradling profile having inner inward angling side walls 143 that rise to edges 144 that define the sides of a recess 145. In certain embodiments, the recess 145 includes a knurled surface 147 to assist in retaining a cable placed therein.

The clip securement feature 140 further presents first and second outer side walls 146, 148 to either side of the channel 142. Each of the first and second side walls 146, 148 includes first and second tabbed edges 150 that define a slot 152 into which the respective spring clip 116, 118 is inserted helping to retain the respective spring clip 116, 118 proximate the respective outer side wall 146, 148. Each of the first and second outer side walls 146, 148 further includes a ratchet surface 154 to which the respective spring clip 116, 118 interfaces. The ratchet surface 154 is an elongate surface presenting a plurality of teeth 156 enabling the respective spring clip 116, 118 to be secured at a plurality of locations along the surface 154. As such, the positioning of the respective spring clip 116, 118 relative to the clip securement feature 140 can be adjusted to accommodate cables of differing diameters.

The inner surface 130 of the face 128 of each of the first and second body portions 110, 112 includes a plurality of alignment posts 158 that interface with corresponding cavities (not shown) of the unshielded in-line connector 10. The alignment posts 158 assist in centering the unshielded in-line connector 10 within the first and second body portions 110, 112 of the shielded in-line connector 100. The inner surface 130 of the face 128 further includes a centrally located ratchet strip 160 having a plurality of teeth 162. In certain embodiments the teeth 162 of the ratchet strip 160 interface with the teeth 25 of the ratchet strip 23 (see FIGS. 1A-1B) of the shielded in-line connector 10 to prevent slippage/movement of the shielded in-line connector 10 within the shielded connector 100. The outer surface 132 of the face 128 of each of the first and second body portions 110, 112 also includes a ratchet strip 164 with a plurality of teeth 165. The ratchet strip 164 provides a grippable surface for manual handling of the shielded in-line connector 100 and further provides a surface for interfacing with ratchet strips of other shielded in-line connectors 100 to assist in preventing slippage of proximate stacked shielded in-line connectors 100.

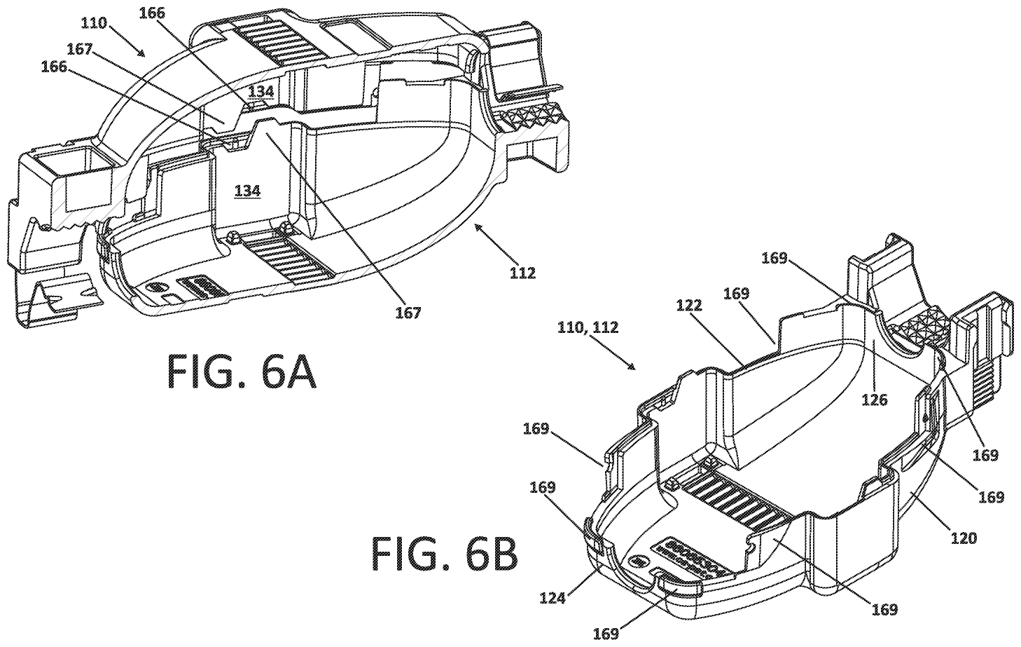

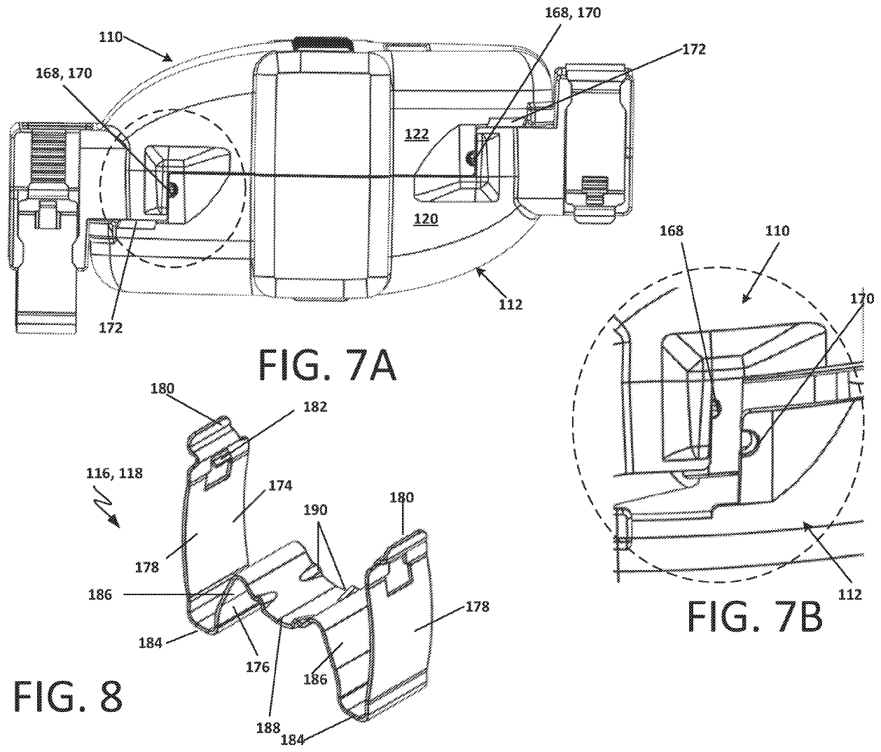

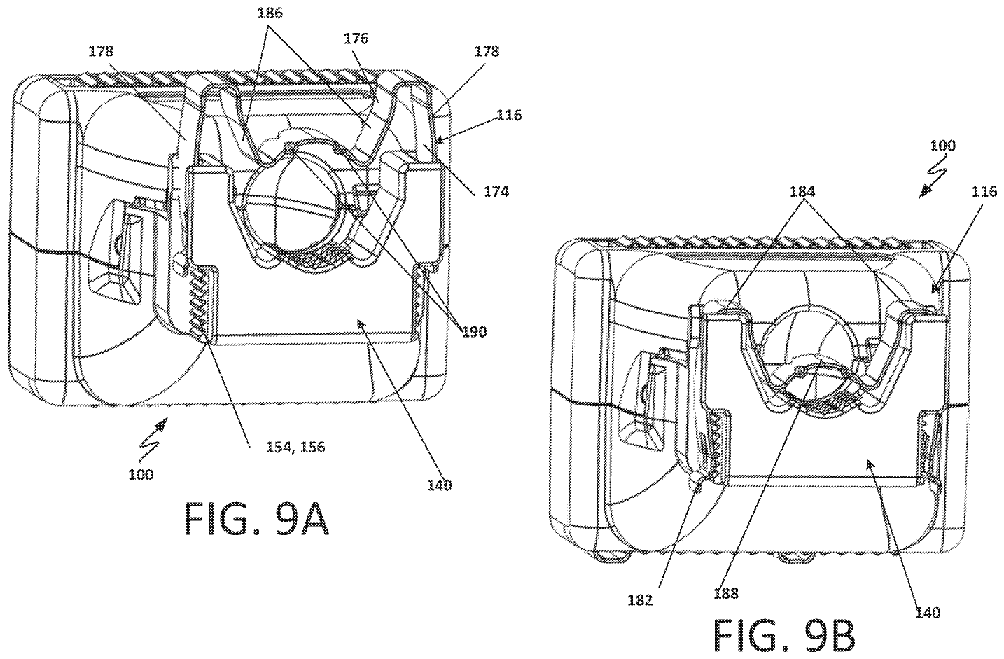

Referring to FIGS. 6A-6B and 7A-7B, features for removably securing the first and second body portions 110, 112 can be appreciated. Specifically, FIG. 6A illustrates that each shoulder projection 134 of each of the first and second body portions 110, 112 includes a press fit rib 166 that interfaces with a fin-shaped wall 167 on the opposing body portion 110, 112 to removably secure the first body portion 110 to the second body portion 112 and to create an electrical contact between the two shield halves, e.g., the first and second body portions 110, 112. Notably, each of the spring clips 116, 118 is electrically coupled to only one of the halves of the shield, e.g., only one of the body portions 110, 112, thus, the interface between the rib 166 and fin-shaped wall 167 ensures that all components of the shielded in-line connector 100 are ultimately electrically connected.

FIG. 6B illustrates that each of the first and second body portions 110, 112 includes a plurality of lip edge features 169 that run about the top of the exterior walls 120, 122, 124, 126 e.g., at each corner of first and second end walls 124, 126, as well as along each of the first and second side walls 120, 122. The lip edge features 169 provide an overlapping construction of the first and second body portions 110, 112 when coupled to one another. This overlapping construction helps to prevent the escape or infiltration of electromagnetic waves between the inner connector, e.g., non-shielded inline connector 10, and the outside environment.

FIGS. 7A-7B illustrate that each of the first and second side walls 120, 122 of each of the first and second body portions 110, 112 includes a tab 168 and tab recess 170 to receive a respective one of the tabs 168 providing four interfacing locations between the first and second body portion 110, 112 in addition to the four interfacing locations provided by the press fit ribs 166. The interface locations enable one to snap together the first and second body portion 110, 112 by hand to form the housing 114 of the shielded in-line connector 100. Further, each of first and second side walls 120, 122 of each of the first and second body portions 110, 112 include a release slot 172 enabling insertion of a flathead screwdriver to release the first body portion 110 from the second body portion 112. The ability to release the first body portion 110 from the second body portion 112 provides the opportunity to reuse the shielded in-line connector 100 if needed.

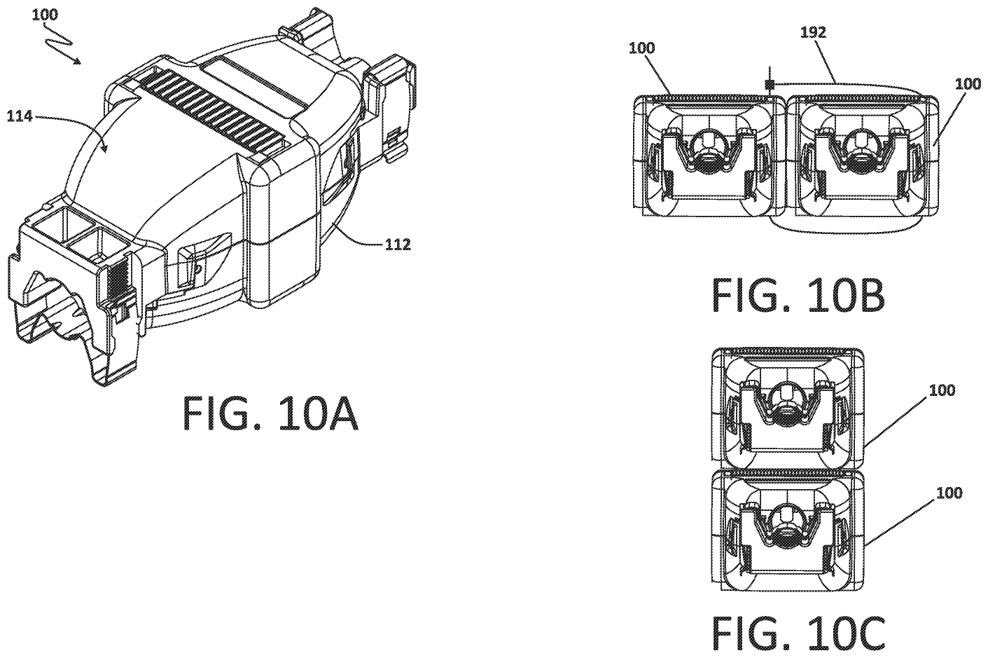

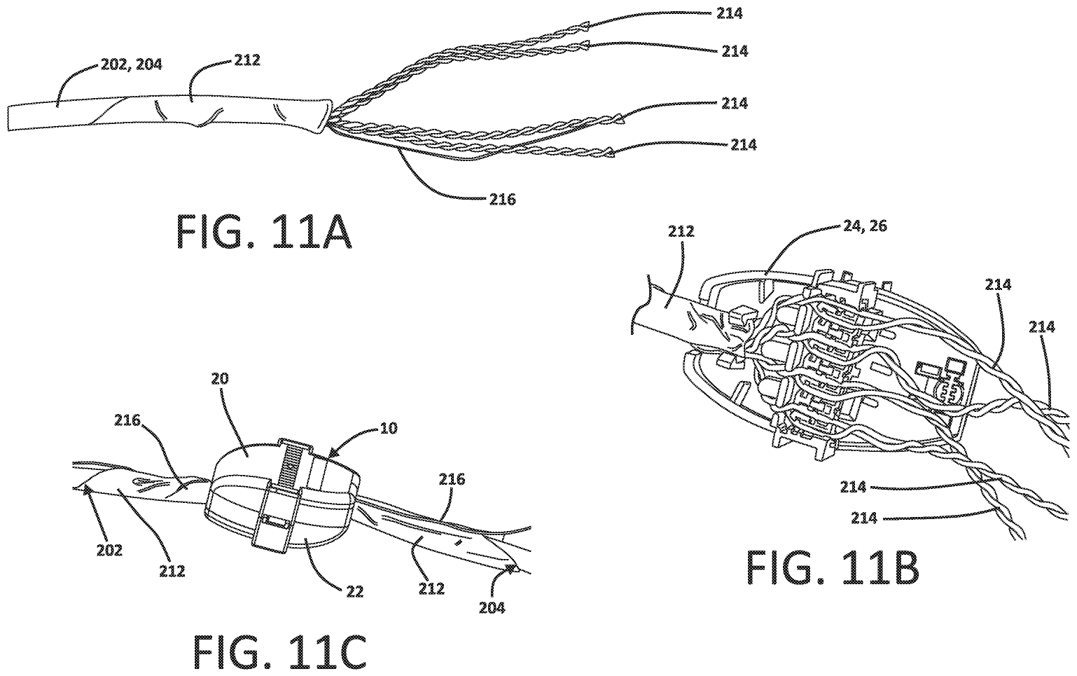

Features of the identical first and second spring clips 116, 118 can be appreciated with respect to FIGS. 8 and 9A-9B. Each of the first and second spring clips 116, 118 is a unitary component defined by an inner surface 174 and an outer surface 176. Each end of the first and second spring clips 116, 118 includes a pair of elongate side walls 178 with each of the pair including an outward extending tab 180 and an inward extending tab 182. Each of the inward extending tabs 182 interfaces with a tooth 156 of the ratchet surface 154, see FIG. 9B, of the clip securement feature 140 enabling the first and second spring clips 116, 118 to be height adjustable. The outward extending tabs 180 are usable to pull outward and release the respective inward extending tabs 182 from the respective ratchet surface 154. Each of the first and second spring clips 116, 118 includes a transition section 184 to an inwardly angled section 186 corresponding to the cradling profile and inward angling side walls 143 of the clip securement feature 140. The inwardly angled sections 186 then transition to form a single arch 188.

The arch 188 includes a plurality of indents 190 protruding away from the inner surface 174 of the first and second spring clips 116, 118. The indents 190 assist in fixing the position of a cable passing under the single arch 188 when the respective spring clip 116, 118 is secured to the clip securement feature 140. The outward extending tabs 180 of each of the spring clips 116, 118 can be pulled outward, away from the clip securement feature 140 to release the clip 116, 118. When secured to the clip securement feature 140 so as to be in contact with an underlying cable, the first and second spring clips establish electrical coupling with a shield of the cable (e.g., foil, drain wire and/or wire mesh) and with the first and second body portions 110, 112 of the connector. The first and second spring clips 116, 118 further function as a strain relief device for the cable helping to prevent mechanical force applied to an exterior of the cable from being transferred to the electrical terminations within the unshielded connector 10.

FIGS. 10A-10C illustrate that the shielded in-line connector 100 can be used in conjunction with the unshielded in-line connector in a single connector application, e.g. FIG. 10A, or in a multi-connector application where shielded in-line connectors are positioned side-by-side, e.g. FIG. 10B, or stacked, e.g., FIG. 10C. In a multi-connector application cable ties 192 can be used to secure one shielded in-line connector 100 to another.

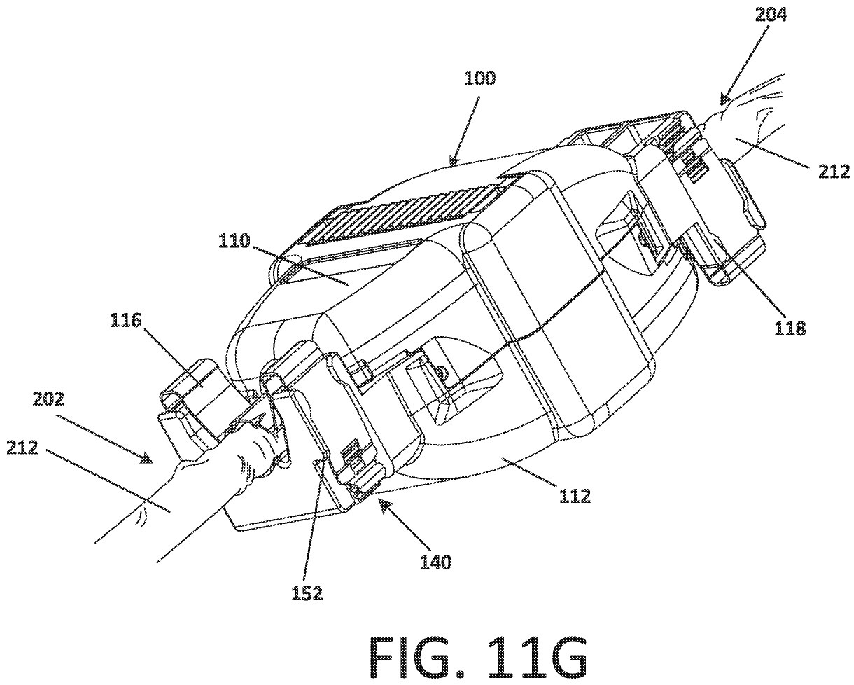

FIGS. 11A-11G Illustrate a method for connectorizing first and second shielded twisted pair cables 202, 204 utilizing the unshielded in-line connector 10 and shielded in-line connector 100 of the present disclosure.

Referring to FIG. 11A, each shielded twisted pair cable 202, 204 has a portion of a jacket 210 removed revealing underlying shielding foil 212. The shielding foil 212 is folded back and twisted completely about the jacket 210 to reveal one or more pairs of conductors 214. A drain wire 216 should also be folded back to lie against the shielding foil 212.

Referring to FIG. 11B the one or more pairs of conductors 214 of each shielded twisted pair cable 202, 204 are then terminated in their respective wiring caps 24, 26 (see FIG. 1A), and the conductors 214 of one shielded twisted pair cable 202 are electrically coupled to the second shielded twisted pair cable 204 with the dual-ended IDCs 30 (see FIG. 1A).

Referring to FIG. 11C, the first and second base 20, 22 are then placed about the coupled wiring caps 24, 26 and secured to one another to complete assembly of the unshielded in-line connector 10. The shielding foil 212 and drain wire 216 remain accessible outside the unshielded in-line connector 10.

Referring to FIG. 11D, the unshielded in-line connector 10 is placed within either of the body portions 110, 112 (in this instance second body portion 112) positioning at least a portion of the shielding foil 212 and the drain wire 216 within the channel 142 of the clip securement feature 140.

Referring to FIG. 11E, the first body portion 110 is placed atop the second body portion 112 and manually pressed together resulting in the closed configuration of the housing 114 of the shielded in-line connector 100 illustrated in FIG. 11F. The housing 114 is now ready receive the first and second spring clips 116, 118.

Referring to FIG. 11G, each spring clip 116, 118 is received within their respective slot 152 of the clip securement feature 140 and pressed in a first direction until the respective spring clip 116, 118 is in tight contact with the shielding foil 212 and drain wire 216, and the respective spring clip 116, 118 is interfaced with the ratchet surface 154 (see FIG. 4) of the clip securement feature 140. The assembly of the shielded in-line connector 100 is now complete. Any additional shielding foil 212 and/or drain wire 216 extending beyond the shielded in-line connector 100 can be trimmed away.

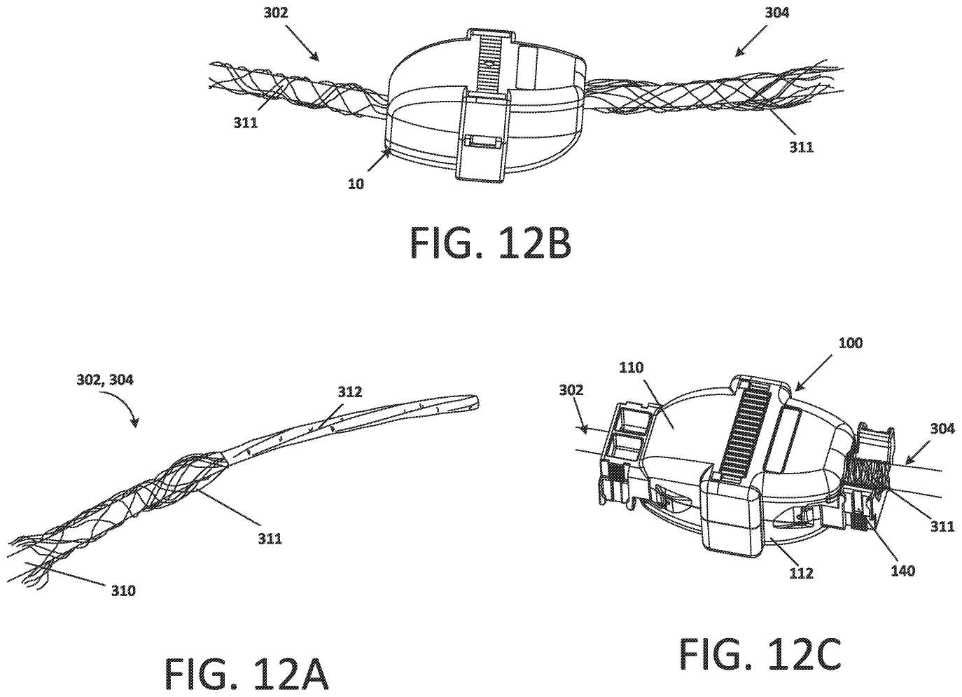

FIGS. 12A-12C illustrate modifications to the method described in FIGS. 11A-11G when a shielded twisted pair cable includes a braided shield alone or in combination with shielding foil.

Referring to FIG. 12A, a cable 302, 304 is illustrated having a both a braided shield 311 and a shielding foil 312. The braided shield 311 is folded back over a jacket 310 of the cable 302, 304 and the shielding foil 312 is trimmed away to reveal the underlying one or more twisted pairs of conductors as shown in FIG. 11A; the process is the same with a cable having only a braided shield, however, no trimming of a shielding foil is required.

Referring to FIG. 12B, the one or more twisted pairs of conductors of each cable 302, 304 are terminated in the wiring caps 24, 26 as illustrated in FIG. 11B, and the first and second base 20, 22 are placed about the wiring caps 24, 26 to complete assembly of the unshielded in-line connector 10.

Referring to FIG. 12C, the braided shield 311 is twisted and bunched around the first and second cable openings 28, 30 (see FIGS. 1A-1B) of the assembled unshielded in-line connector 10. The first and second body portions 110, 112 of the shielded in-line connector 100 are then placed about the unshielded in-line connector 10 and pressed together to establish the housing 114 of the shielded in-line connector. The bunched braided shield 311 preferably does not extend beyond the confines of the housing but rather lies within the channel 142 of the clip securement feature 140. The spring clips 116, 118 can then be placed in contact with the bunches braided shield 311 and secured to the housing 114, as described with reference to FIG. 11G, to complete assembly of the shielded in-line connector.

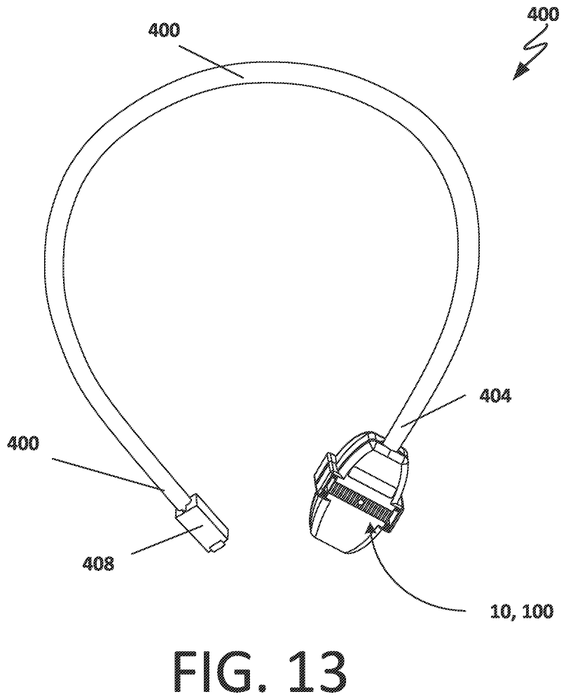

Referring to FIG. 13, the shielded in-line connector 100, containing the unshielded in-line connector 10, can be utilized in a pigtail configuration 400, where a length of shielded twisted pair cable 402 has a first end 404 pre-terminated to the connectors 10 and 100 and a second end 406 that is unterminated or pre-terminated with a different type of connector 408. In the pigtail configuration 400, each of the connectors 10 and 100 can be opened, and subsequently re-secured, to accommodate conductor coupling and shield coupling of another shielded twisted pair cable.

It will be appreciated that aspects of the above embodiments may be combined in any way to provide numerous additional embodiments. These embodiments will not be described individually for the sake of brevity.

While the present invention has been described above primarily with reference to the accompanying drawings, it will be appreciated that the invention is not limited to the illustrated embodiments; rather, these embodiments are intended to disclose the invention to those skilled in this art. In the drawings, like numbers refer to like elements throughout. Thicknesses and dimensions of some components may be exaggerated for clarity.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of the present invention.

Spatially relative terms, such as “under”, “below”, “lower”, “over”, “upper”, “top”, “bottom” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “under” or “beneath” other elements or features would then be oriented “over” the other elements or features. Thus, the exemplary term “under” can encompass both an orientation of over and under. The device may be otherwise oriented (rotated 90 degrees or at other orientations) and the spatially relative descriptors used herein interpreted accordingly.

Well-known functions or constructions may not be described in detail for brevity and/or clarity. As used herein the expression “and/or” includes any and all combinations of one or more of the associated listed items.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises”, “comprising”, “includes” and/or “including” when used in this specification, specify the presence of stated features, operations, elements, and/or components, but do not preclude the presence or addition of one or more other features, operations, elements, components, and/or groups thereof.

Herein, the terms “attached”, “connected”, “interconnected”, “contacting”, “mounted” and the like can mean either direct or indirect attachment or contact between elements, unless stated otherwise.

Although exemplary embodiments of this invention have been described, those skilled in the art will readily appreciate that many modifications are possible in the exemplary embodiments without materially departing from the novel teachings and advantages of this invention. Accordingly, all such modifications are intended to be included within the scope of this invention as defined in the claims. The invention is defined by the following claims, with equivalents of the claims to be included therein.

What is claimed:

1. A shielded in-line connector, comprising:
a conductive first body portion having a first clip securement feature;
a conductive second body portion having a second clip securement feature, the conductive second body portion secured to the conductive first body portion to define a unshielded connector-receiving cavity, to define a first shielded cable opening and to define a second shielded cable opening, the first clip securement feature being proximate the first shielded cable opening and the second clip securement feature being proximate the second opening, the first clip securement feature including a first channel supportive of a first shielded cable that extends through the first shielded cable opening, the first shielded cable having an exposed portion of a shield , the second clip securement feature including a second channel supportive of a second shielded cable that extends through the second shielded cable opening, the second shielded cable having an exposed portion of a shield; and
conductive first and second clips, the first clip adjustably secured to the first clip securement feature in a position placing the first clip in direct contact with the exposed portion of the shield of the first shielded cable and the second clip adjustably secured to the second securement feature in a position placing the second clip in direct contact with the exposed portion of the shield of the second shielded cable.

2. The shielded in-line connector of claim 1, wherein the first body portion is oriented in a first direction, wherein the second body portion is identical to the first body portion, and wherein the second body portion is oriented in a direction opposite the first direction.

3. The shielded in-line connector of claim 1, wherein the first clip securement feature is oriented in a direction opposite second clip securement feature.

4. The shielded in-line connector of claim 1, wherein each of the first and second clip securement features include a ratchet surface that interfaces with the respective first and second clips.

5. The shielded in-line connector of claim 4, wherein each of the first and second clip securement features include first and second exterior side walls to either side of the first channel and the second channel, respectively, and wherein each of the first and second exterior side walls include the ratchet surface.

6. The shielded in-line connector of claim 1, wherein each of the first and second clips includes a centrally positioned cable diameter-accommodating arch.

7. The shielded in-line connector of claim 6, wherein each of the first and second clips includes a plurality of cable-gripping indents on the arch.

8. The shielded in-line connector of claim 6, wherein each of the first and second clips includes first and second side walls to either side of the arch and wherein each of the first and second side walls of the first and second clips includes an inward extending tab that interfaces with a ratchet surface of the respective first and second clip securements features.

9. The shielded in-line connector of claim 8, wherein each of the first and second side walls of the first and second clips includes an outward extending release tab.

10. The shielded in-line connector of claim 6, wherein each of the first and second clips include first and second side walls and wherein each of the first and second clip securement features include a slot opening proximate each of the first and second exterior side walls to receive the respective first and second side walls of the first and second clips.

11. The shielded in-line connector of claim 1, wherein each of the first and second body portions includes a shoulder projection that includes a cable tie-receiving slot.

12. The shielded in-line connector claim 1, wherein each of the first and second channels includes a knurled surface.

13. The shielded in-line connector of claim 1, wherein each of the first and second body portions include an interior and an exterior ratchet strip.

14. The shielded in-line connector of claim 1, wherein the second body portion is releasably secured to the first body portion and wherein each of the first and second portion include a tool-receiving release slot to release the second body portion from the first body portion.

15. A shielded in-line connector system comprising:
an unshielded in-line connector electrically coupling a first shielded twisted pair cable and a second shielded twist pair cable; and
a shielded in-line connector containing the unshielded in-line connector, the shielded in-line connector comprising:
a conductive first body portion having a first clip securement feature;
a conductive second body portion having a second clip securement feature, the conductive second body portion secured to the conductive first body portion to define a unshielded connector-receiving cavity, to define a first shielded cable opening and to define a second shielded cable opening, the first clip securement feature being proximate the first shielded cable opening and the second clip securement feature being proximate the second opening, the first clip securement feature including a first channel supportive of a first shielded cable that extends through the first shielded cable opening, the first shielded cable having an exposed portion of a shield , the second clip securement feature including a second channel supportive of a second shielded cable that extends through the second shielded cable opening, the second shielded cable having an exposed portion of a shield; and
conductive first and second clips, the first clip adjustably secured to the first clip securement feature in a position placing the first clip in direct contact with the exposed portion of the shield of the first shielded cable and the second clip adjustably secured to the second securement feature in a position placing the second clip in direct contact with the exposed portion of the shield of the second shielded cable.

16. The shielded in-line connector system of claim 15, wherein the first body portion is oriented in a first direction, wherein the second body portion is identical to the first body portion, and wherein the second body portion is oriented in a direction opposite the first direction.

17. The shielded in-line connector system of claim 15, wherein the first clip securement feature is oriented in a direction opposite second clip securement feature.

18. The shielded in-line connector system of claim 15, wherein each of the first and second clip securement features include a ratchet surface that interfaces with the respective first and second clips.

19. The shielded in-line connector system of claim 18, wherein each of the first and second clip securement features include first and second exterior side walls to either side of the first channel and the second channel, respectively, and wherein each of the first and second exterior side walls include the ratchet surface.

20. A method coupling first and second shielded twisted pair cables, comprising:
for each of the first and second shielded twisted pair cables:
stripping a portion of a jacket of the respective cable;
folding back a shield, of the respective cable, over a remaining portion of the jacket of the cable to reveal one or more twisted pairs of conductors;
connecting the one or more pairs of conductors to one or more pairs of contacts within an unshielded in-line connector to electrically couple the first and second shielded twist pair cables;
enclosing the unshielded in-line connector with a shielded in-line connector, the shielded in-line connector including a conductive housing having first and second cable openings to accommodate the first and second shielded cables extending from the unshielded in-line connector, the shielded in-line connector including a first clip securement feature proximate the first cable opening and a second clip securement feature proximate the second cable opening, each of the first and second securement features including a cable-supporting channel that supports the respective first and second shielded twisted pair cable;
securing a first and second conductive clip to a respective one of the first and second clip securement features to position the respective first and second conductive clips in direct contact with the shield of the respective first and second shielded cables.
